(19) United States
(12) Patent Application Publication
(10) Pub. No.: US 2009/0066854 A1
(43) Pub. Date: Mar. 12, 2009

(54) UNIVERSAL REMOTE CONTROL UNIT

(75) Inventor: Rony Samimrad, Los Angeles, CA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(73) Assignee: GENERAL SOUND COMPANY, LTD., Los Angeles, CA (US)

(21) Appl. No.: 11/853,444

(22) Filed: Sep. 11, 2007

(51) Int. Cl. H04N 5/44

(52) U.S. Cl. 348/734

(57) ABSTRACT

A universal remote control having universal inputs for controlling a plurality of devices, such as a TV, DVD player, etc. In addition, the unit has a clock and a radio, preferably both AM and FM, and other features such as a flashlight, alarm, LCD indicator, etc., all in one compact unit.

### BACKGROUND

1. General Background

The present invention relates generally to remote control units, and, more particularly, to remote control units for remotely controlling a plurality of devices and also acting as a flashlight, alarm, clock, sleep timer and radio.

2. Related Art

Remote Control Units have gained widespread popularity for use in remotely controlling home entertainment systems which typically include several devices such as a television set, DVD players, a cable box or converter, one or more videocassette recorders, and an audio system. Often, with each device, the manufacturer will supply a remote control unit for use in remotely controlling that one device.

A universal remote control unit provides a single unit having a plurality of operating modes for controlling a plurality of devices. Each operating mode allows a user to remotely control a respective one of the devices. Typically, a universal remote control unit includes a plurality of mode push buttons, e.g., CABLE, TV, Satellite, DVD, AUX, Audio and VCR push buttons, which correspond to the different devices to be controlled and which are used to directly change the operating mode of the universal remote control unit.

Changing operating modes of the universal remote control is often accomplished by simply pressing the appropriate mode push button, i.e., CABLE, SAT, DVD, AUX, AUDIO, or VCR push button. For example, with the universal remote control unit in the cable mode, to turn on the cable box, a user presses a POWER push button. Next, if the user wants to turn on the television set, the user must first press the TV push button then the POWER push button. Thereafter, in order to operate the cable box again, the user must then press the CABLE push button before selecting, for example, the channel up or down push buttons on the universal remote control unit. Later, if the user wishes to turn off the television and the cable box, the user must press the CABLE push button, the POWER push button, the TV push button, and then the Power push button.

Generally, such universal remote control units only control the various devices as set forth above. Some such units have a clock built into the remote unit but such clocks generally merely show the time.

There is a need for a universal remote control unit that, in addition to the usual functions for remotely controlling a number of devices in a single unit, also includes a clock with a built-in alarm, a sleep timer, a flashlight, etc.

### SUMMARY

It is an object of this invention to provide a universal remote control unit which controls a plurality of devices, the functions associated with each respective device, and also includes a radio, alarm clock, sleep timer and flashlight.

It is a further object of this invention whereby the remote control unit allows for switching between the LED clock of the unit and the radio.

It is still further an object of this invention wherein the radio in the foregoing object includes both AM and FM.

These and other objects are preferably accomplished by providing a universal remote control unit having the usual universal inputs for controlling a plurality of devices, such as TV, DVD, etc. In addition, the unit has a clock and a radio, both FM and AM, and other features, such as a flashlight, alarm, LCD indicator, etc., all in one compact unit.

### DRAWINGS

The above-mentioned features and objects of the present disclosure will become more apparent with reference to the following description taken in conjunction with the accompanying drawings wherein like reference numerals denote like elements and in which:

FIG. 1 is a front plan view of a universal remote control unit according to the present invention.

FIGS. 2 and 3 are alternative views of the clock screen of FIG. 1 illustrating selection of AM and FM radio respectively.

FIG. 4 is a block diagram of certain features of the unit of FIGS. 1 to 3; and

FIG. 5 is a rear view of the unit of FIGS. 1 to 3.

### DETAILED DESCRIPTION

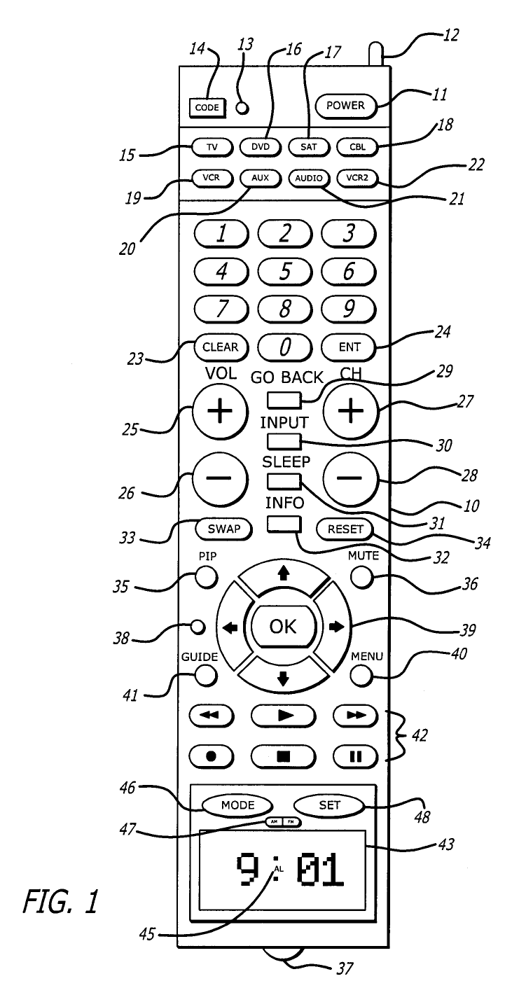

Referring now to FIG. 1 of the drawing, a universal remote control unit 10 is shown having built-in processing means adapted to control a number of devices as is well known in the art. Thus, unit 10 includes individual mode buttons for each device that turns on and off and a code button for inputting codes into the unit 10, as is well known in the art, for controlling a particular brand of device.

For example, device 10 includes a power button 11, an antenna 12 for the radio, which can be pulled out or retracted back into the unit, an LED indicator 13 that lights up when one of the device operating buttons is pressed, and a code button 14 for inputting a device code into unit 10 from a list supplied to the user, as is well known in the art.

Unit 10 also, by way of example only, has a plurality of buttons 15 through 22 for actuating various devices, such as TV, DVD, SAT, Cable, VCR, AUX, AUDIO and VCR 2, respectively. A plurality of buttons numbered 0 through 9 are also provided for inputting the aforementioned codes. If the user makes a mistake in the codes, a clear button 23 is provided. Volume is controlled by up and down buttons 25, 26, respectively, whereas channel surfing can be accomplished by up and down buttons 27, 28, respectively.

As is well known in such units, a GO BACK button 29, an INPUT button 30, a Sleep button 31 and an INFO (Information) button 32 is provided. SWAP (33) and RESET (34) buttons are provided. A PIP (picture in picture) button 35 and a MUTE button 36 is provided.

As particularly contemplated in the invention, a light 37 for illuminating an area is provided at the lower end of unit 10. This light may be activated by button 38.

Also as is well known in the art, programming push buttons with up, down, right, left, and OK or enter may be provided at area 39. Just below and to the right and left of area 39 are Menu and Guide buttons 40, 41, respectively. Below buttons 40, 41 are conventional DVD and VCR control buttons in area 42 as is well known in the art.

The LED Clock section 43 shows the present time 44 and has a symbol or letters AL (at 45) to indicate when the alarm is being set. The MODE button 46 allows one to alternate between setting the clock, setting the time, setting the alarm, the radio, etc. The Radio replaces the clock when actuated, as will be discussed, and a separate switch 47 may be provided for switching between AM and FM. Alternatively, the switch from the clock to a radio may be controlled by the MODE button 46. A Set button 48 is provided for setting the time, the alarm, etc.

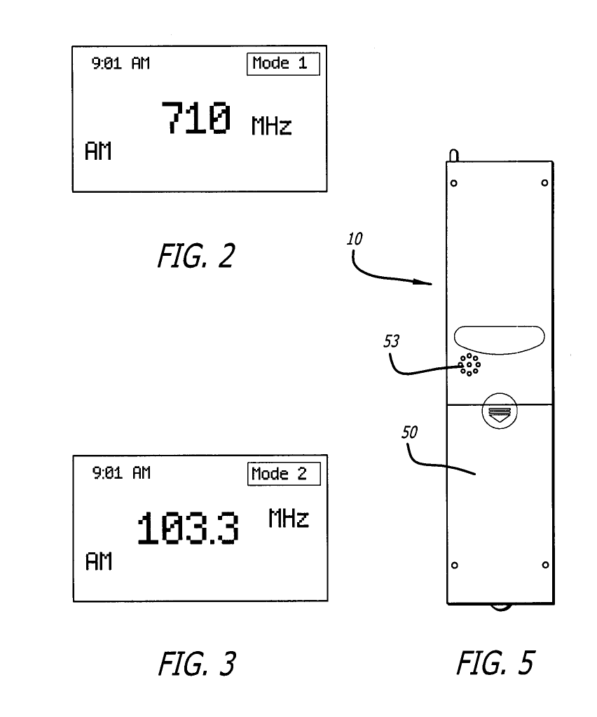

FIGS. 2 and 3 show screens for AM and FM, respectively. The present time may be displayed in the upper left corner.

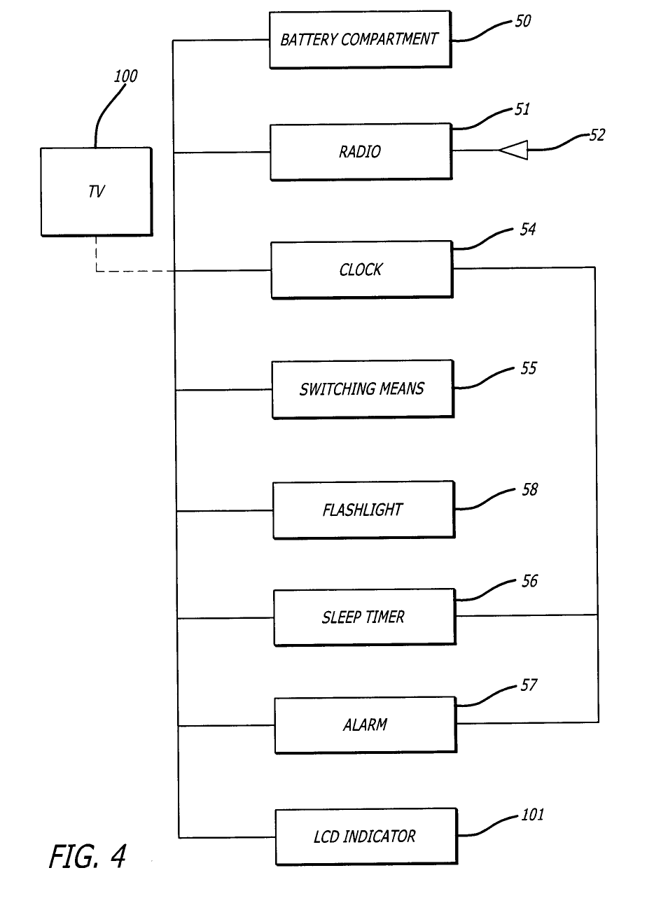

FIG. 4 is a block diagram of a portion of the features of unit 10 which communicates with a remote TV 100. Thus, a battery compartment 50 (see also FIG. 5) electronically communicates with a radio 51, coupled to a speaker 52, (see FIG. 5—internal speaker 52 communicates with apertures 53 opening out of the back of unit 10). Battery 50 also communicates with clock 54 coupled to both switching means 55 and a sleep timer 56 and alarm 57. Battery compartment 50 also communicates with flashlight 58. LED Indicator 101 is also provided in the system.

It is to be understood that the various other features, not shown in FIG. 4, also communicate with compartment 50, as is well known in the remote control art, and are actuated when batteries are placed in compartment 50.

Clock section 43 may be an LCD clock and operated by a separate battery so it remains on when no batteries are in compartment 50. The unit 10 may include a battery saver, and the LED indicator 13 lights up to provide feedback for the various functions. The LED indicator will remain lit when a valid key is pressed, and remain lit as long as the key is pressed and turns off when the key is released. The LED indicator 13 also blinks in Programming Mode or in Menu Mode to provide feedback to the user as is well known in the art.

A separate Code List covering various devices, such as a TV, DVD, etc., may be provided to the user along with the unit 10 to input various codes to operate the devices, also as is well known in the art. Direct Code Entry, Auto Code Search and Manual Code Search may be provided. On screen menus are provided to assist the user in navigating through the various features.

Sleep timer 56 may be set by the user to automatically turn off the TV at a desired time. That is, assuming one entered the correct code to control the TV, pressing and releasing the TV key 15, then pressing Sleep key 30 for a predetermined time, such as 3 seconds, will turn on the LED indicator 31. The user then releases the Sleep key and, using the numbered keys, enters the desired time in minutes. Once this time is entered, LED indicator 13 turns off and the user can watch TV until that set time is reached and the TV automatically turns off.

Selectively pushing button 38 turns light 37 on and off. Mode button 46 can be used to activate the radio (FIGS. 2 and 3) with button 47 used to set for AM or FM. Antenna 13, retractable into unit 10, may be pulled out for the FM radio. The unit 10 may include a built in antenna (not shown) for the AM radio as is well known in the portable radio art.

Clock 43 is normally displayed and the time may be set by Mode button 46 and Set button 48. The alarm clock may also be set accordingly using these buttons and indicated at AL (reference number 45) on the clock screen. The LED indicator 13 will illuminate depending on the key pressed.

There can be seen that I have disclosed a universal remote control unit 10 that can be used to control a number of devices and also provides a clock, radio, flashlight, LED indicator and sleep timer, along with the usual control functions for a variety of units.

From the present description, it will be appreciated by those skilled in the art that a suitable display, e.g., liquid crystal display having a touch screen, may be used instead of push buttons for allowing a user to select an operating mode and/or a function for remote control of the devices. In addition, it will be appreciated by those skilled in the art that instead of illuminatable push buttons, one or more light emitting diodes may be disposed on the universal remote control unit to indicate the current operating mode, indicate a change in the operating mode, etc. Further, it will be appreciated that other equipment may be controlled by unit 10 in addition to those illustrated in FIG. 1. The operating instructions of certain devices may be explained in the instruction sheet that comes with the unit being programmed, such as PIP for TV, operating buttons for a DVD player, etc., so further discussion is deemed unnecessary.

Thus, while various embodiments of the present invention have been illustrated and described, it will be appreciated to those skilled in the art that many changes and modifications may be made thereunto without departing from the spirit and scope of the invention.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A universal remote control unit for remotely controlling a plurality of devices, said universal remote control unit comprising:
function means for enabling a user to select a plurality of functions in connection with the operation of the plurality of devices,
a transmitter;
a processor having a plurality of operating modes each of which corresponds to a different one of the plurality of devices, and said processor being operable in each of said plurality of operating modes to control transmission from said transmitter in response to activation of said function means by the user; and
said unit including an LED clock and mode means associated with said clock for switching between said clock and a radio.

2. The unit of claim 1 wherein said mode means include radio mode means for switching between AM and FM radio.

3. The unit of claim 2 including a retractable antenna on said unit electronically coupled to said FM radio.

4. The unit of claim 1 including a flashlight having an actuating button on said unit and a beam of light function activated by said flashlight actuating button to emit a beam of light from said unit.

5. The unit of claim 1 wherein said mode means includes means for both setting the time of said clock and setting an alarm on said clock.

6. The unit of claim 1 wherein said unit includes a TV control button, an LED indicator and sleep timer means associated with both said TV control button and said LED indicator to program predetermined times to automatically turn off said TV.

7. The unit of claim 1 including an LED indicator on said unit coupled to said function means for indicating activation of certain of said functions.

8. A television system comprising:
a television set; and
a universal remote control unit as in claim 1 for remote control of said television set.

9. A method for operating a universal remote control unit having a plurality of devices, each of the plurality of operating modes corresponding to a different one of the plurality of devices, the method comprising:
providing means for enabling a user to select the plurality of operating modes;
providing an LED clock on said unit having a radio associated therewith; and
switching between said clock and said radio.

10. The method of claim 9 including the steps of:
providing a flashlight on said unit activated by having a button on said unit and providing a beam of light function activated by said flashlight activation button to emit a beam of light from said unit.

11. The method of claim 9 including the step of providing a mode means on said unit for both setting the time of said clock and setting an alarm on said clock.

12. The method of claim 9 including the step of providing an LED indicator on said unit for indicating when a function is activated.

13. The method of claim 12 including the step of providing means on said unit associated with both a TV control button on said unit and said LED indicator to program a predetermined time to automatically turn off said TV.

14. A television system comprising:
a television set; and
a universal remote control unit as in claim 13 for remote control of said television set.
